(19) United States
(12) Patent Application Publication
(10) Pub. No.: US 2022/0051140 A1
(43) Pub. Date: Feb. 17, 2022

(54) MODEL CREATION METHOD, MODEL CREATION APPARATUS, AND PROGRAM

(71) Applicant: NEC Corporation, Minato-ku, Tokyo (JP)

(72) Inventor: Yusuke OI, Tokyo (JP)

(73) Assignee: NEC Corporation, Minato-ku, Tokyo (JP)

(21) Appl. No.: 17/435,785

(22) PCT Filed: Feb. 17, 2020
(86) PCT No.: PCT/JP2020/006001

§ 371 Date: Sep. 2, 2021

(30) Foreign Application Priority Data
Mar. 13, 2019 (JP) 2019-046365

(51) Int. Cl. G06N 20/00

(52) U.S. Cl. CPC G06N 20/00

(57) ABSTRACT

A model creation apparatus includes a selector configured to select a model based on output results obtained by inputting pieces of learning data to registered models, a learning unit configured to create a new model by inputting the pieces of learning data to the selected model and performing machine learning, and a registration unit configured to register the created new model such that the new model is associated with the selected model.

### TECHNICAL FIELD

The present invention relates to a model creation method, model creation apparatus, and program.

### BACKGROUND ART

Creating a prediction model by machine-learning a great amount of data and automatically determining various phenomena using this prediction model has become a practice in various fields in recent years. Examples of created prediction models include a model for determining at a production site whether a product is normal or defective, based on images of the product and a model for classifying the type of a part based on images of the part. A model need not be created using images and may be created by machine-learning various types of data, such as speech, text, or numerical data.

On the other hand, creating an accurate prediction model by machine learning requires learning a great amount of data for a long time. However, there may be a limit to the time or the amount of data. Techniques to address this problem include one called transfer learning that creates a new model using a prediction model created by previously learning a great amount of data. By using a previously prepared prediction model serving as a base, an accurate prediction model can be created in a short time and with a small amount of data. An example of transfer learning is disclosed in Patent Document 1.

Patent Document 1: Japanese Unexamined Patent Application Publication (Translation of PCT Application) No. 2018-525734

### SUMMARY OF INVENTION

However, creation of a prediction model using transfer learning as described above involves the following problems. A first problem is that transfer learning uses existing models and therefore if there are many target models, it takes time and efforts to search for a model suitable for a challenge to be solved among the models. For example, a failure to select a suitable model leads to disadvantages, such as one that learning is rather delayed. A second problem is that the management of models created using transfer learning is complicated and it is difficult to search for a suitable model using these models.

Accordingly, an object of the present invention is to solve the above problems, that is, the difficulties in selecting a suitable model using transfer learning.

A model creation method according to an aspect of the present invention includes selecting a model based on output results obtained by inputting pieces of learning data to registered models, creating a new model by inputting the pieces of learning data to the selected model and performing machine learning, and registering the created new model such that the new model is associated with the selected model.

A model creation apparatus according to another aspect of the present invention includes a selector configured to select a model based on output results obtained by inputting pieces of learning data to registered models, a learning unit configured to create a new model by inputting the pieces of learning data to the selected model and performing machine learning, and a registration unit configured to register the created new model such that the new model is associated with the selected model.

A program according to yet another aspect of the present invention is a program for implementing, in an information processing apparatus, a selector configured to select a model based on output results obtained by inputting pieces of learning data to registered models, a learning unit configured to create a new model by inputting the pieces of learning data to the selected model and performing machine learning, and a registration unit configured to register the created new model such that the new model is associated with the selected model.

The present invention thus configured is able to select a suitable model using transfer learning.

### BRIEF DESCRIPTION OF THE DRAWINGS

FIG. 1 is a block diagram showing a configuration of a model creation apparatus according to a first example embodiment of the present invention;

FIG. 2 is a diagram showing the state of a process performed by the model creation apparatus disclosed in FIG. 1;

FIG. 3 is a diagram showing the state of a process performed by the model creation apparatus disclosed in FIG. 1;

FIG. 4 is a diagram showing the state of a process performed by the model creation apparatus disclosed in FIG. 1;

FIG. 5 is a diagram showing the state of a process performed by the model creation apparatus disclosed in FIG. 1;

FIG. 6 is a diagram showing the state of a process performed by the model creation apparatus disclosed in FIG. 1;

FIG. 7 is a diagram showing the state of a process performed by the model creation apparatus disclosed in FIG. 1;

FIG. 8 is a diagram showing the state of a process performed by the model creation apparatus disclosed in FIG. 1;

FIG. 9 is a flowchart showing an operation of the model creation apparatus disclosed in FIG. 1;

FIG. 10 is a flowchart showing an operation of the model creation apparatus disclosed in FIG. 1;

FIG. 11 is a flowchart showing an operation of the model creation apparatus disclosed in FIG. 1;

FIG. 12 is a block diagram showing a hardware configuration of a model creation apparatus according to a second example embodiment of the present invention;

FIG. 13 is a block diagram showing a configuration of the model creation apparatus according to the second example embodiment of the present invention; and

FIG. 14 is a flowchart showing an operation of the model creation apparatus according to the second example embodiment of the present invention.

### DESCRIPTION OF EMBODIMENTS

### First Example Embodiment

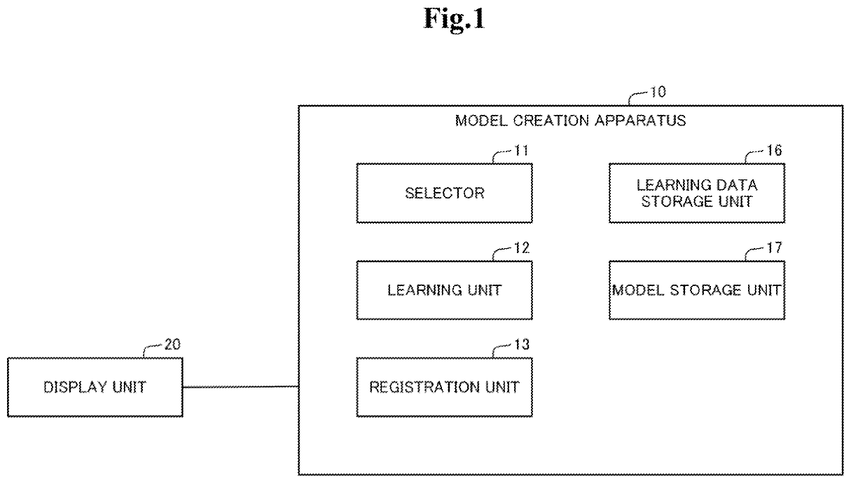

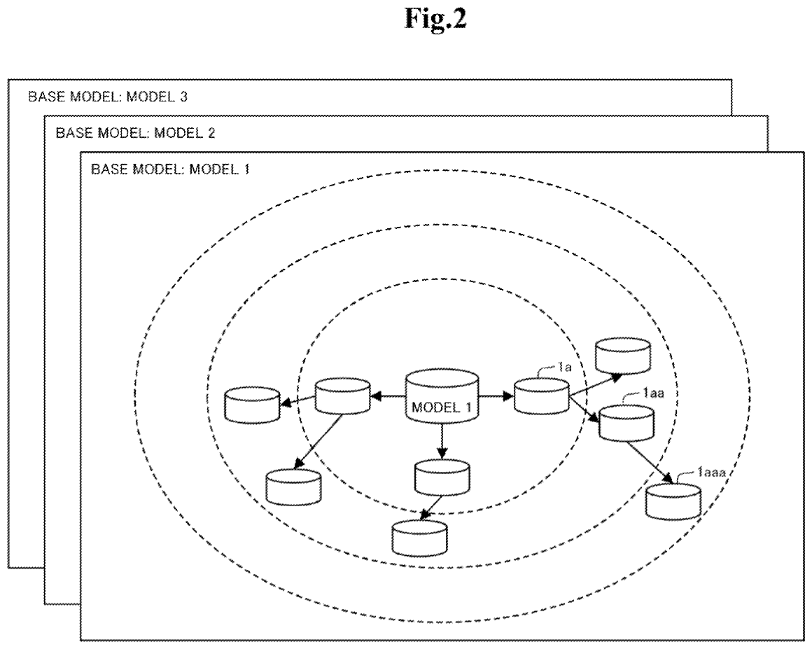

A first example embodiment of the present invention will be described with reference to FIGS. 1 to 11. FIG. 1 is a diagram showing a configuration of a model creation apparatus, and FIGS. 2 to 11 are diagrams showing an operation of the model creation apparatus.

[Configuration] A model creation apparatus 10 according to the present invention is an apparatus for creating a model that outputs a predicted output value with respect to one input by performing machine learning using previously prepared learning data. In particular, in the present invention, the model creation apparatus 10 has a function of performing transfer learning that creates a new model by previously storing some models and machine-learning these models. For example, the model creation apparatus 10 creates a model for determining at a production site whether a product is normal or defective, based on images of the product, or a model for classifying the type of a part based on images of the part. Note that a model created by the model creation apparatus 10 may be of any type and data used to machine-learning a model may be of any type, such as speech, text or numerical data.

The model creation apparatus 10 consists of one or more information processing apparatuses each including an arithmetic logic unit and a storage unit. As shown in FIG. 1, the model creation apparatus 10 includes a selector 11, a learning unit 12, and a registration unit 13 implemented by execution of a program by the arithmetic logic unit(s). The storage unit(s) of the model creation apparatus 10 includes a learning data storage unit 16 and a model storage unit 17. The respective elements will be described in detail below.

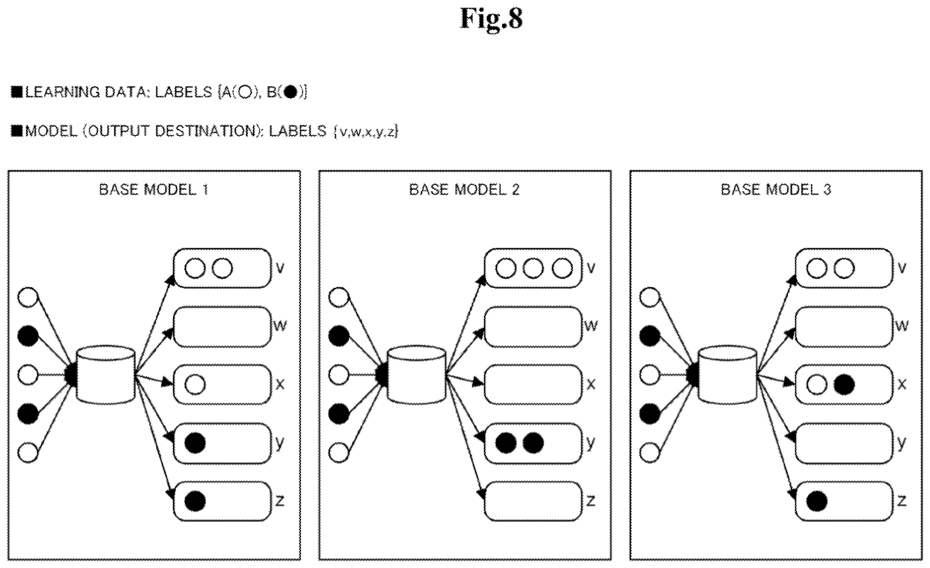

The learning data storage unit 16 is storing learning data (data for learning) used to create a model. Each learning data is data to be inputted to create a model by machine learning and is, for example, data on captured images or data on measured measurements. Each learning data is provided with a label serving as a teacher signal representing the correct answer of the learning data. For example, in the present embodiment, it is assumed that each learning data is provided with one of two labels {A,B}, as shown in FIG. 8.

The model storage unit 17 is also storing multiple pieces of model data, such as a previously prepared registered model and or a newly created registered model (to be discussed later). Specifically, as shown in FIG. 2, the model storage unit 17 is storing a base model 1 as a previously prepared model. It is also storing a child model 1a, which is a transfer-destination model newly created using the base model 1 as the transfer source, as will be described later. Here, the model storage unit 17 is storing the base model 1 and the child model 1a created using the base model 1 as the transfer source such that the base model 1 and child model 1a are associated with each other, in particular, such that the parent-child relationship is clarified. Thus, when displaying the association between the models as will be described later, the association between the models is shown by an arrow directed from the base model 1 to the child model 1a, which is the transfer destination, as shown in FIG. 2. The association between the models will be described later. The model storage unit 17 is also storing a model newly created using the child model 1a as the transfer source, that is, a child model 1aa of the child model 1a and further a child model 1aaa of the child model 1aa. That is, the model storage unit 17 are storing the models spanning some generations. Also in this case, the model storage unit 17 is storing the models such that the transfer source-transfer destination relationships, that is, the parent-child relationships between the models are clarified.

Similarly, the model storage unit 17 is storing model data with respect to base models 2 and 3. That is, the model storage unit 17 is storing these base models, child models created using the base models as the transfer sources, and the parent-child relationships between these models. While FIG. 2 shows only the three base models as examples, any number of base models may be registered. Also, the number of generations of registered child models is not limited to the number shown in FIG. 2.

The selector 11 selects one piece of model data as the transfer source from among the pieces of model data stored in the model storage unit 17, inputs each learning data to the selected model, checks the output result of the model, and evaluates the model in terms of whether the output result corresponds to the label of the learning data. Specifically, the selector 11 selects the model data as follows.

First, the selector 11 reads all the base models 1, 2, and 3 from the model storage unit 17. Then, the selector 11 reads pieces of learning data from the learning data storage unit 16, inputs the pieces of learning data to the base models 1, 2, and 3, and compiles the output results from the base models 1, 2, and 3. Here, it is assumed that the output layers of the base models 1, 2, and 3 produce outputs using one of six labels {v,w,x,y,z}, as shown in FIG. 8. It is also assumed that the pieces of learning data to be inputted are each provided with one of the two labels {A(∘), B(●)}, as shown in FIG. 8. It is also assumed that by inputting the pieces of learning data to the base models 1, 2, and 3, output results as shown in FIG. 8 are obtained. Then, the respective models are evaluated in the following two terms serving as criteria:
(1) whether pieces of learning data provided with different labels are not aggregated in an output result provided with an identical label of each model, that is, whether pieces of learning data provided with an identical label are aggregated in an output result provided with an identical label of each model; and
(2) whether the number of labeled output results of each model is smaller.

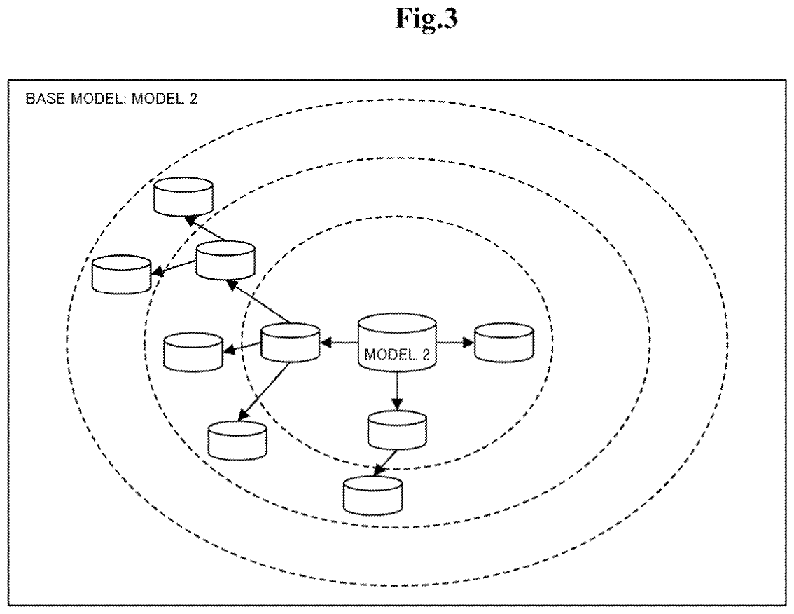

In the example of FIG. 8, the base model 2 is thought to satisfy the above (1), because pieces of learning data provided with the label A(∘) or B(●) belong to an output result provided with the label v or an output result provided with the label y. The base model 2 is also thought to satisfy the above (2), because the labeled output results of the base model 2 are only the output result provided with the label v and the output result provided with the label y and the number thereof is two. The selector 11 selects the base model 2 as shown in FIG. 3 from among the base models 1, 2, and 3 based on this evaluation.

If there are some generations of child models associated with the selected base model 2, as shown in FIG. 3, the selector 11 also evaluates those child models and finally selects one model. For this reason, the selector 11 searches for child models associated with the selected base model 2.

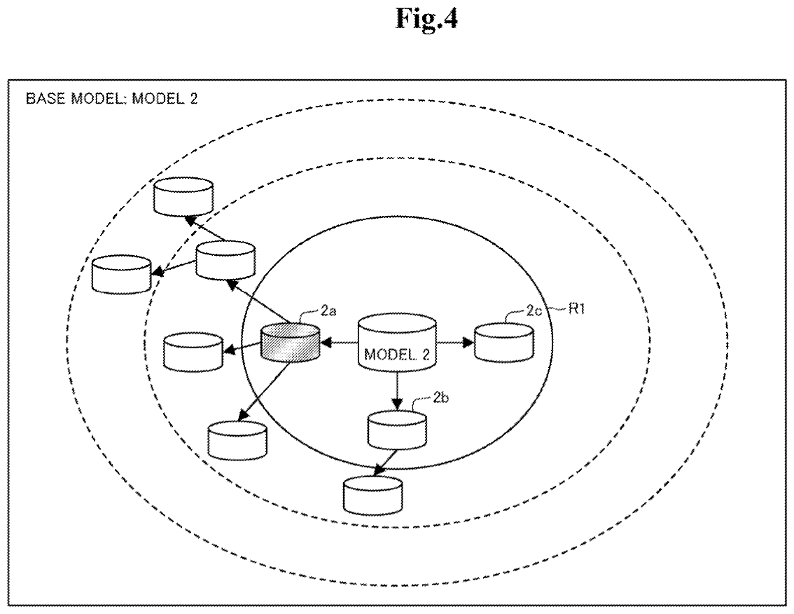

Specifically, the selector 11 first reads information on the selected base model 2 as shown in FIG. 3 from the model storage unit 17. The selector 11 also reads pieces of learning data from the learning data storage unit 16. The selector 11 then checks whether there are child models associated with the base model 2, based on the information on the selected base model 2. If child models 2a, 2b, and 2c are associated with the selected base model 2, as shown in a range R1 of FIG. 4, the selector 11 evaluates the child models 2a, 2b, and 2c to check whether there is a model that can serve as a better transfer source than the base model 2. As is done in the evaluation of the base models 1, 2, and 3, the selector 11 evaluates the child models 2a, 2b, and 2c based on the labels of the pieces of learning data and the labels of the output results of the child models 2a, 2b, and 2c obtained by inputting the pieces of learning data to these child models. Here, for example, it is assumed that the child model 2a is evaluated better than the base model 2 and thus selected, as shown in FIG. 4.

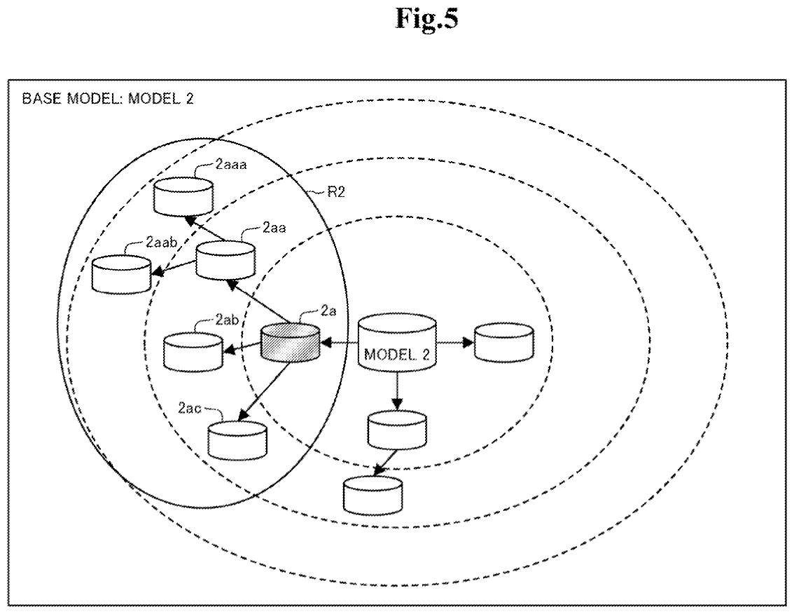

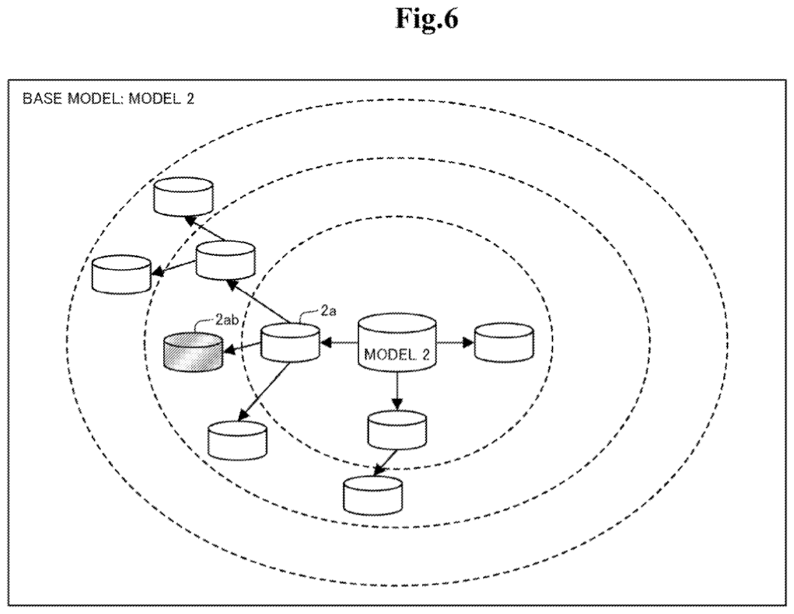

If child models 2aa, 2ab, and 2ac are associated with the selected child model 2a as subordinates of the child model 2a, as shown in FIG. 5, the selector 11 evaluates these child models in a similar manner. Assuming that the child model 2aa is selected based on this evaluation, the selector 11 evaluates child models 2aaa and 2aab serving as subordinates of the child model 2aa. That is, in this example, the selector 11 searches for child models shown in a range R2 of FIG. 5. As seen above, the selector 11 evaluates the models including the initially selected base model 2 and the child models associated with the base model 2 and finally selects one model. Here, for example, it is assumed that the child model 2ab, which is the third-generation model starting from the base model 2, is selected, as shown in FIG. 6.

If there is no child model associated with the initially selected base model 2, the selector 11 determines the base model 2 as the transfer-source model. Similarly, if one child model is selected and there is no child model associated with the selected child model as a subordinate, the selector 11 determines the selected child model as the transfer-source model.

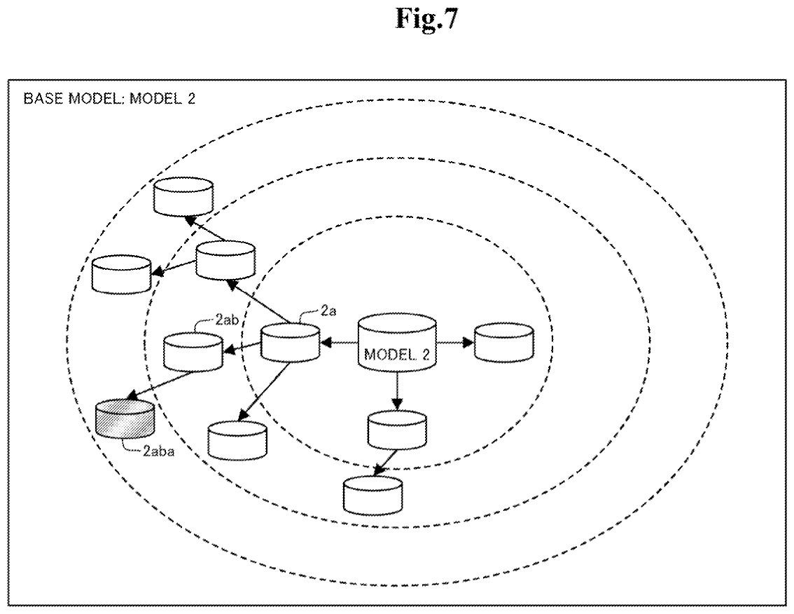

The learning unit 12 reads the model determined as the transfer source from the model storage unit 17. The learning unit 12 also reads pieces of learning data from the learning data storage unit 16. The learning unit 12 then creates a new model by inputting the pieces of learning data to the model determined as the transfer source and performing machine learning. For example, the learning unit 12 performs so-called transfer learning or fine tuning, which uses an existing model determined as the transfer source. Here, it is assumed that a model 2aba corresponding to the learning data is newly created using the child model 2ab as the transfer source, as shown in FIG. 7.

The registration unit 13 stores information on the created new model 2aba in the model storage unit 17. At this time, as shown in FIG. 7, the registration unit 13 registers the created model 2aba such that the model 2aba is associated with the transfer-source model 2ab. The created new model aba registered as shown in FIG. 7 serves as a candidate transfer-source model when creating a model later.

Also, when selecting or learning a model as described above, or in accordance with a request from a user, the registration unit 13 outputs model data stored in the model storage unit 17 so that the model data is displayed on a display unit 20. At this time, the registration unit 13 outputs the model data such that the association between the models is clarified. For example, when outputting the model data of the base model 2, the registration unit 13 outputs the model data such that the transfer source and transfer destination are connected by an arrow in a diagram as shown in FIG. 7 and thus the relationship between the transfer-source model and transfer-destination model, that is, the parent-child relationship is clarified.

### [Operation]

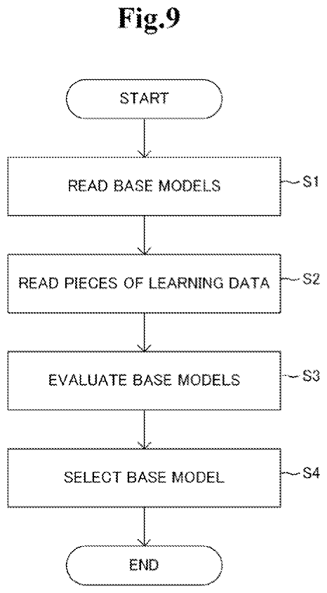

Next, operations of the model creation apparatus 10 thus configured will be described mainly with reference to the flowcharts of FIGS. 9 to 11. First, referring to the flowchart of FIG. 9, the operation when selecting a base model will be described.

First, the model creation apparatus 10 reads all the base models from the model storage unit 17 (step S1). The model creation apparatus 10 also reads labeled pieces of learning data from the learning data storage unit 16 (step S2).

The model creation apparatus 10 then predicts the read pieces of learning data using the read base models, compiles the results, and evaluates the base models (step S3). Here, the model creation apparatus 10 evaluates the base models in terms of which model has unlabeled the pieces of learning data better. For this reason, if the output results as shown in FIG. 8 are obtained by inputting pieces of learning data provided with, for example, one of two labels {A, B} to the base models, as described above, the base model 2 as shown in FIG. 3 is selected (step S4).

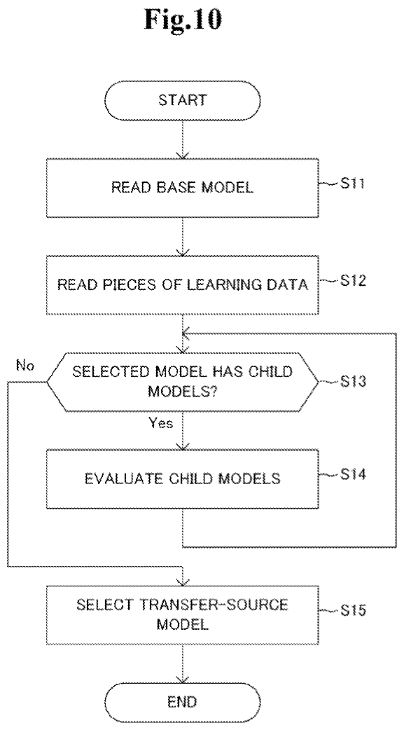

Next, referring to the flowchart of FIG. 10, the operation when searching for child models will be described. Here, if already created transfer learning models are present as subordinates of the selected base model, the best model is selected from among the models including the base model.

First, the model creation apparatus 10 reads the model data of the base model selected as described above from the model storage unit 17 (step S11). For example, if the base model 2 is selected, the model creation apparatus 10 reads the model data of the base model 2 as shown in FIG. 3. The model creation apparatus 10 also reads labeled pieces of learning data from the learning data storage unit 16 (step S12).

Then, the model creation apparatus 10 checks whether there are models (child models) created using the selected base model 2 as the transfer source (step S13). If the base model 2 has no child model (NO in step S13), the model creation apparatus 10 no longer searches for models and determines the base model 2 as the transfer-source model (step S15). On the other hand, if the base model 2 has child models (YES in step S13), the model creation apparatus 10 evaluates the child models to determine whether there is a better transfer source than the base model among the child models (step S14). Here, the child models are evaluated based on output results obtained by inputting the pieces of learning data to each child model. The child models may be evaluated using a method similar to the above evaluation method of the base model, or any other method.

The model creation apparatus 10 evaluates all the models until there are no longer models below the child models, and selects the best model as the transfer-source model (step S15). For example, the model creation apparatus 10 selects the child model 2ab, which the third generation model starting from the base model 2, as shown in FIG. 6.

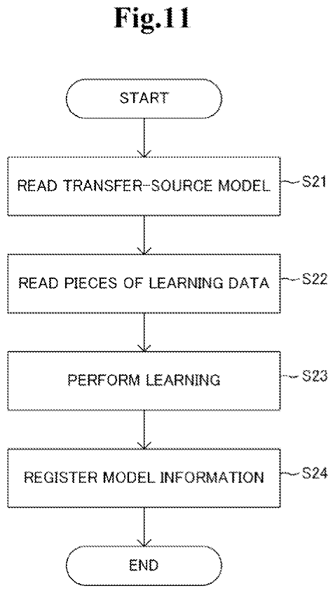

Next, referring to the flowchart of FIG. 11, the operation when performing transfer learning using the selected transfer-source model will be described. First, the model creation apparatus 10 reads the model data of the model selected as described above from the model storage unit 17 (step S21). For example, if the base model 2ab is selected as shown in FIG. 6, the model creation apparatus 10 reads the model data of the model 2ab. The model creation apparatus 10 also reads labeled pieces of learning data from the learning data storage unit 16 (step S22).

The model creation apparatus 10 then performs transfer learning of the labeled pieces of learning data using the read model 2ab as the transfer-source model (step S23). As a result of the learning, the model creation apparatus 10 creates a new model and stores information on the new model in the model storage unit 17 (step S24). At this time, the model creation apparatus 10 stores the created new model in the model storage unit 17 such that the model is associated with the transfer-source model as a child model of the transfer-source model, that is, as a subordinate thereof. For example, as shown in FIG. 7, the model creation apparatus 10 stores the created new model 2aba such that the model 2aba is associated with the transfer-source model 2ab as a subordinate.

When selecting or learning a model as described above, or in accordance with a request from a user, the model creation apparatus 10 may output information indicating the association between the models as shown in FIGS. 3 to 7 stored in the model storage unit 17 to the display unit 20 so that the information is displayed on the display unit 20.

As seen above, the present invention first inputs the pieces of learning data to the registered models and selects the model based on the output results from the models, creates the new model by inputting the pieces of learning data to the selected model and performing machine learning, and registers the newly created model such that the newly created model is associated with the selected model. This allows for selecting a model from the registered models in accordance with the characteristics of the learning data and creating a new model by performing machine learning using such a model. This means that a model suitable to the learning data can be selected in transfer learning. Also, by registering the source model used in transfer learning and the model newly created by transfer learning in an associated manner, a model to be transferred can be selected from among the models registered in an associated manner. As a result, a more suitable model can be selected in transfer learning.

### Second Embodiment

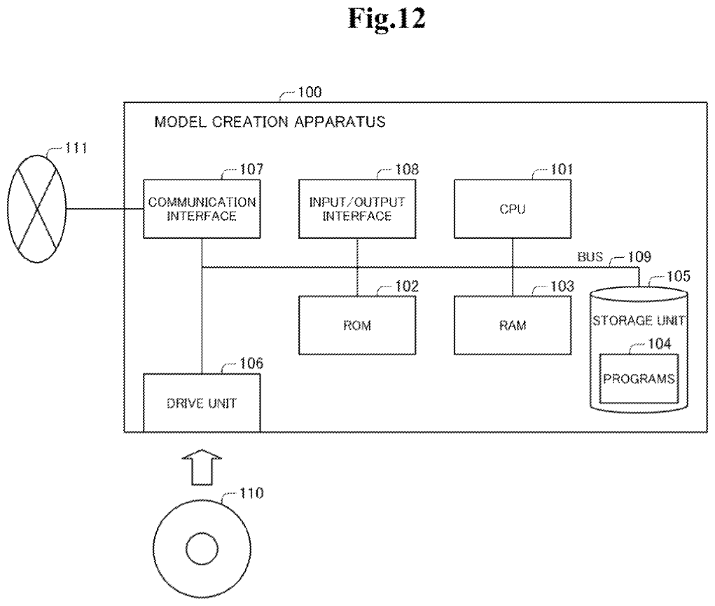

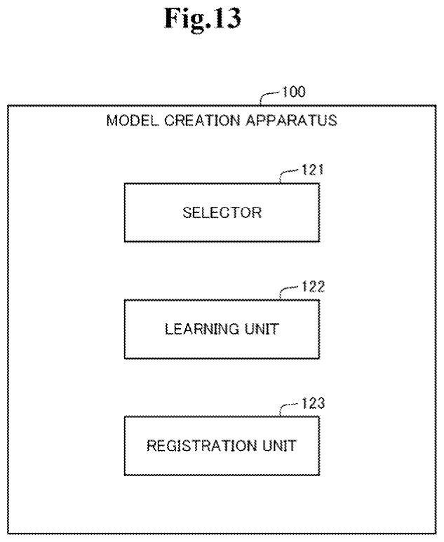

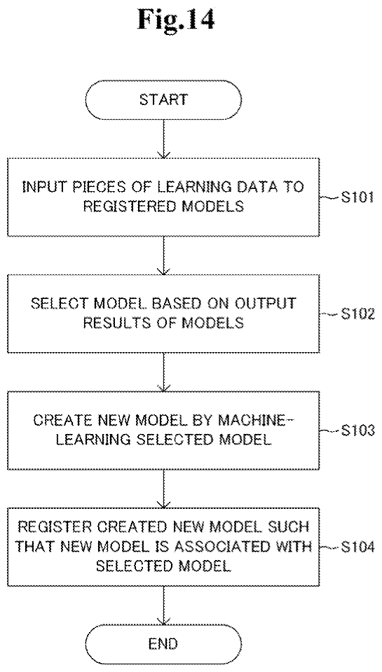

Next, a second example embodiment of the present invention will be described with reference to FIGS. 12 to 14. FIGS. 12 and 13 are block diagrams showing a configuration of a model creation apparatus according to the second example embodiment. FIG. 14 is a flowchart showing an operation of the model creation apparatus. In the present embodiment, configurations of the model creation apparatus and the processing method performed by the model creation apparatus described in the first example embodiment are outlined.

First, referring to FIG. 12, a hardware configuration of a model creation apparatus 100 according to the present embodiment will be described. The model creation apparatus 100 consists of a typical information processing apparatus and includes, for example, the following hardware components:

a CPU (central processing unit) 101 (arithmetic logic unit);

a ROM (read-only memory) 102 (storage unit);

a RAM (random-access memory) 103 (storage unit);

programs 104 loaded into the RAM 103;

a storage unit 105 storing the programs 104;

a drive unit 106 that writes and reads to and from a storage medium 110 outside the information processing apparatus;

a communication interface 107 that connects with a communication network 111 outside the information processing apparatus;

an input/output interface 108 through which data is outputted and inputted; and

a bus 109 through which the components are connected to each other.

When the CPU 101 acquires and executes the programs 104, a selector 121, a learning unit 122, and a registration unit 123 shown in FIG. 13 are implemented in the model creation apparatus 100. For example, the programs 104 are previously stored in the storage unit 105 or ROM 102, and the CPU 101 loads and executes them into the RAM 103 when necessary. The programs 104 may be provided to the CPU 101 through the communication network 111. Also, the programs 104 may be previously stored in the storage medium 110, and the drive unit 106 may read them therefrom and provide them to the CPU 101. Note that the selector 121, learning unit 122, and registration unit 123 may be implemented by an electronic circuit.

The hardware configuration of the information processing apparatus serving as the model creation apparatus 100 shown in FIG. 12 is only illustrative and not limiting. For example, the information processing apparatus does not have to include one or some of the above components, such as the drive unit 106.

The model creation apparatus 100 performs a model creation method shown in the flowchart of FIG. 14 using the functions of the selector 121, learning unit 122, and registration unit 123 implemented based on the programs.

As shown in FIG. 14, the image model creation apparatus 100:
inputs learning data to registered models (step S101);
selects a model based on the output results of the models (step S102);
creates a new model by inputting the learning data to the selected model and performing machine learning (step S103); and
registers the created new model such that the new model is associated with the selected model (step S104).

The present invention thus configured is able to select a model from the registered models in accordance with the characteristics of the learning data and to create a new model by performing machine learning using this model. Thus, the present invention is able to select a model suitable to the learning data in transfer learning. Also, by previously registering the new model created using transfer learning such that the new model is associated with the source model used in transfer learning, a model to be transferred can be selected from among the models registered in an associated manner. As a result, a more suitable model can be selected in transfer learning.

The above programs can be stored in various types of non-transitory computer-readable media and provided to a computer. The non-transitory computer-readable media include various types of tangible storage media. The non-transitory computer-readable media include, for example, a magnetic recording medium (for example, a flexible disk, a magnetic tape, a hard disk drive), a magneto-optical recording medium (for example, a magneto-optical disk), a CD-ROM (read-only memory), a CD-R, a CD-R/W, and a semiconductor memory (for example, a mask ROM, a PROM (programmable ROM), an EPROM (erasable PROM), a flash ROM, a RAM (random-access memory)). The programs may be provided to a computer by using various types of transitory computer-readable media. The transitory computer-readable media include, for example, an electric signal, an optical signal, and an electromagnetic wave. The transitory computer-readable media can provide the programs to a computer via a wired communication channel such as an electric wire or optical fiber, or via a wireless communication channel.

While the present invention has been described with reference to the example embodiments and so on, the present invention is not limited to the example embodiments described above. The configuration or details of the present invention can be changed in various manners that can be understood by one skilled in the art within the scope of the present invention.

The present invention is based upon and claims the benefit of priority from Japanese Patent Application 2019-046365 filed on Mar. 13, 2019 in Japan, the disclosure of which is incorporated herein in its entirety by reference.

### <Supplementary Notes>

Some or all of the embodiments can be described as in Supplementary Notes below. While the configurations of the model creation method, model creation apparatus, and program according to the present invention are outlined below, the present invention is not limited thereto.

### (Supplementary Note 1)

A model creation method comprising:

selecting a model based on output results obtained by inputting pieces of learning data to registered models;

creating a new model by inputting the pieces of learning data to the selected model and performing machine learning; and

registering the created new model such that the new model is associated with the selected model.

(Supplementary Note 2)

The model creation method according to Supplementary Note 1, further comprising:

if there are models registered so as to be associated with the selected model, selecting a new model based on output results obtained by inputting the pieces of learning data to the models registered so as to be associated with the selected model;

creating another new model by inputting the pieces of learning data to the selected new model and performing machine learning; and

registering the created other new model such that the other new model is associated with the selected new model.

### (Supplementary Note 3)

The model creation method according to Supplementary Note 1 or 2, wherein the selecting the model comprises selecting the model based on labels attached to the pieces of learning data and labels of the output results obtained by inputting the pieces of learning data to the registered models.

### (Supplementary Note 4)

The model creation method according to Supplementary Note 3, wherein the selecting the model comprises if the pieces of learning data provided with an identical label are inputted to a registered model and if the pieces of learning data provided with the identical label are aggregated in an output result provided with an identical label of the registered model, selecting the registered model.

### (Supplementary Note 5)

The model creation method according to Supplementary Note 3 or 4, wherein the selecting the model comprises if the pieces of learning data are inputted to a registered model and if the number of labeled output results of the registered model is smaller, selecting the registered model.

### (Supplementary Note 6)

The model creation method according to any one of Supplementary Note 1 to 5, further comprising outputting associations between the models for display.

### (Supplementary Note 7)

A model creation apparatus comprising:

a selector configured to select a model based on output results obtained by inputting pieces of learning data to registered models;

a learning unit configured to create a new model by inputting the pieces of learning data to the selected model and performing machine learning; and

a registration unit configured to register the created new model such that the new model is associated with the selected model.

### (Supplementary Note 7.1)

The model creation apparatus according to Supplementary Note 7, wherein

if there are models registered so as to be associated with the selected model, the selector selects a new model based on output results obtained by inputting the pieces of learning data to the models registered so as to be associated with the selected model,

the learning unit creates another new model by inputting the pieces of learning data to the created new model and performing machine learning, and

the registration unit registers the created other new model such that the other new model is associated with the selected new model.

### (Supplementary Note 7.2)

The model creation apparatus according to Supplementary Note 7 or 7.1, wherein when selecting the model, the selector selects the model based on labels attached to the pieces of learning data and labels of the output results obtained by inputting the pieces of learning data to the registered models.

### (Supplementary Note 7.3)

The model creation apparatus according to Supplementary Note 7.2, wherein if the pieces of learning data provided with an identical label are inputted to a registered model and if the pieces of learning data provided with the identical label are aggregated in an output result provided with an identical label of the registered model, the selector selects the registered model.

### (Supplementary Note 7.4)

The model creation apparatus according to Supplementary Note 7.2 or 7.3, wherein if the pieces of learning data are inputted to a registered model and if the number of labeled output results of the registered model is smaller, the selector selects the registered model.

### (Supplementary Note 7.5)

The model creation apparatus according to any one of Supplementary Note 7 to 7.4, wherein the registration unit outputs associations between the registered models for display.

### (Supplementary Note 8)

A program for implementing, in an information processing apparatus:

a selector configured to select a model based on output results obtained by inputting pieces of learning data to registered models;

a learning unit configured to create a new model by inputting the pieces of learning data to the selected model and performing machine learning; and

a registration unit configured to register the created new model such that the new model is associated with the selected model.

### DESCRIPTION OF NUMERALS

10 model creation apparatus
11 selector
12 learning unit
13 registration unit
16 learning data storage unit
17 model storage unit
100 model creation apparatus
101 CPU
102 ROM
103 RAM
104 programs
105 storage unit
106 drive unit
107 communication interface
108 input/output interface
109 bus
110 storage medium
111 communication network
121 selector
122 learning unit
123 registration unit

What is claimed is:

1. A model creation method comprising:
selecting a model based on output results obtained by inputting pieces of learning data to registered models;
creating a new model by inputting the pieces of learning data to the selected model and performing machine learning; and
registering the created new model such that the new model is associated with the selected model.

2. The model creation method according to claim 1, further comprising:
if there are models registered so as to be associated with the selected model, selecting a new model based on output results obtained by inputting the pieces of learning data to the models registered so as to be associated with the selected model;
creating another new model by inputting the pieces of learning data to the selected new model and performing machine learning; and another
registering the created other new model such that the other new model is associated with the selected new model.

3. The model creation method according to claim 1, wherein the selecting the model comprises selecting the model based on labels attached to the pieces of learning data and labels of the output results obtained by inputting the pieces of learning data to the registered models.

4. The model creation method according to claim 3, wherein the selecting the model comprises if the pieces of learning data provided with the same label are inputted to a registered model and if the pieces of learning data provided with the same label are aggregated in an output result provided with the same label of the registered model, selecting the registered model.

5. The model creation method according to claim 3, wherein the selecting the model comprises if the pieces of learning data are inputted to a registered model and if the number of labeled output results of the registered model is smaller, selecting the registered model.

6. The model creation method according to claim 1, further comprising outputting associations between the models for display.

7. A model creation apparatus comprising:
a memory storing processing instructions; and
at least one processor configured to execute the processing instructions, the processing instructions comprising:
selecting a model based on output results obtained by inputting pieces of learning data to registered models;
creating a new model by inputting the pieces of learning data to the selected model and performing machine learning; and
registering the created new model such that the new model is associated with the selected model.

8. The model creation apparatus according to claim 7, wherein
the processing instructions comprise:
if there are models registered so as to be associated with the selected model, selecting a new model based on output results obtained by inputting the pieces of learning data to the models registered so as to be associated with the selected model;
creating another new model by inputting the pieces of learning data to the created new model and performing machine learning; and
registering the created other new model such that the other new model is associated with the selected new model.

9. The model creation apparatus according to claim 7, wherein the processing instructions comprise when selecting the model, selecting the model based on labels attached to the pieces of learning data and labels of the output results obtained by inputting the pieces of learning data to the registered models.

10. The model creation apparatus according to claim 9, wherein the processing instructions comprise when selecting the model, if the pieces of learning data provided with the same label are inputted to a registered model and the pieces of learning data provided with the same label are aggregated in an output result provided with the same label of the registered model, selecting the registered model.

11. The model creation apparatus according to claim 9, wherein the processing instructions comprise when selecting the model, if the pieces of learning data are inputted to a registered model and if the number of labeled output results of the registered model is smaller, selecting the registered model.

12. The model creation apparatus according to any one of claim 7, wherein the processing instructions comprise outputting associations between the registered models for display.

13. A non-transitory computer-readable storage medium storing a program for causing an information processing apparatus to perform a process of:
selecting a model based on output results obtained by inputting pieces of learning data to registered models;
creating a new model by inputting the pieces of learning data to the selected model and performing machine learning; and
registering the created new model such that the new model is associated with the selected model.
